(19) United States
(12) Patent Application Publication
(10) Pub. No.: US 2006/0214947 A1
(43) Pub. Date: Sep. 28, 2006

(54) System, method, and computer program product for animating drawings

(75) Inventors: Molly L. Boose, Bellevue, WA (US); Lawrence S. Baum, Bellevue, WA (US); Rodney R. Bard, Ephrata, PA (US); Heather Steinberg, Langhorne, PA (US); Charles L. Smith, Glen Mills, PA (US); Joseph C. Hrin, Glen Mills, PA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 11/087,481

(22) Filed: Mar. 23, 2005

(51) Int. Cl. G09G 5/00

(52) U.S. Cl. 345/619

(57) ABSTRACT

A system, method, and computer program product identify a first drawing comprising a number of graphical objects, display the first drawing, identify a second drawing comprising a number of graphical objects, determine the differences between the graphical objects of the first drawing and the corresponding graphical objects of the second drawing, and thereafter change the display of the graphical objects of the first drawing which are different in the second drawing. Any number of drawings may be identified and compared, and the differences from the preceding drawings may be displayed. Each difference from one drawing to the next represents the occurrence of an event in a system. As the display of the graphical objects is changed, the flow of events within the system is illustrated.

### FIELD OF THE INVENTION

The present invention relates generally to animating drawings, and more particularly, to systems, methods, and computer program products for using a series of static drawings to create an animation of the flow of an event through a complex

### BACKGROUND OF THE INVENTION

Technical illustrations play a critical role in the design, manufacture, maintenance, and troubleshooting of complex systems. Schematic drawings, a class of technical illustrations, are used throughout the life cycle of many types of complex systems, such as aerospace vehicles, as they provide valuable insight into how various systems work and interact with other systems. To fully understand these schematics, one must not only understand the individual components on an illustration, but also the flow of events as various subsystems and individual components within the complex system operate.

A manufacturer of a complex system will often create a textual description, termed a theory of operations, which describes the flow of events. Maintenance or other personnel working for the user of the complex system will often use the theory of operations, in conjunction with corresponding schematic drawings, to identify problems and repair the system.

These textual descriptions can be highly detailed and difficult to understand. Often, maintenance or other personnel will turn to the schematic and its specific theory of operations description in a time-critical situation. Military mission-readiness and commercial economic factors make it increasingly important for maintenance or other personnel to gain an understanding of technical information quickly.

Systems and methods have been developed to facilitate the creation of or improve the functionality of technical illustrations. Such systems and methods are disclosed by U.S. Pat. No. 6,606,731, entitled Intelligent Wiring Diagram System, issued Aug. 12, 2003; U.S. Pat. No. 6,766,331, entitled Method, Computer Program Product, and System for Creating and Viewing an Intelligent Graphics File Including Parts Information, issued Jul. 20, 2004; U.S. patent application Ser. No. 09/971,149, entitled Method, Computer Program Product, and System for Performing Automated Text Recognition and Text Search Within a Graphic File, filed Oct. 4, 2001 and published Dec. 19, 2002 as U.S. Patent Application Publication No. 2002/0191848; U.S. patent application Ser. No. 09/971,283, entitled Method, Computer Program Product, and System for Performing Automated Linking Between Sheets of a Drawing Set, filed Oct. 4, 2001 and published Feb. 6, 2003 as U.S. Patent Application Publication No. 2003/0025734; U.S. patent application Ser. No. 10/396,997, entitled Vector Graphic Normalizer, filed Mar. 25, 2003 and published Oct. 23, 2003 as U.S. Patent Application Publication No. 2003/0197714; U.S. patent application Ser. No. 10/318,921, entitled Apparatus and Methods for Converting Raster Illustrated Parts Images into Intelligent Vector-Layered Files, filed Dec. 13, 2002 and published Jun. 17, 2004 as U.S. Patent Application Publication No. 2004/0114801; and U.S. patent application Ser. No. 10/357,847, entitled Apparatus and Methods for Converting Network Drawings from Raster Format to Vector Format, filed Feb. 4, 2003 and published Aug. 5, 2004 as U.S. Patent Application Publication No. 2004/0151377; which are assigned to The Boeing Company and the contents of which are hereby incorporated in their entirety.

One way to address this problem is to transform the schematic into a training module. This may be done by adding animations and controls that allow the maintenance or other personnel to see a demonstration of how a system, or one or more or its subsystems, works. An animation is typically a series of visual and/or audio indications of motion, activity, and/or change. For example, the maintenance or other personnel could see a signal flow from one component to another which causes a relay to operate, which then causes the signal to flow to another component, which causes a valve to open, which finally releases fluid into a hydraulic system.

Drawing animations that illustrate how a complex system works can significantly reduce the time it takes to master the system. However, animation often requires significant expertise and time. Often, specialized software is required to add animation to technical drawings which were typically created using common drafting software. For complex systems, hundreds or even thousands of individual behaviors must be incorporated into the animation to illustrate the flow of events.

As such, it would be advantageous to develop a system, method, and computer program product for animating technical drawings illustrating how complex systems operate more quickly and easily compared to using specialized animation software.

### BRIEF SUMMARY OF THE INVENTION

A system, method, and computer program product use a sequential series of static drawings to create animations in a more efficient manner. In this regard, a first drawing comprising a number of graphical objects is displayed, a second drawing comprising a number of graphical objects is identified, and differences between the graphical objects of the first drawing and the corresponding graphical objects of the second drawing are determined. The display of the graphical objects of the first drawing which are different in the second drawing may then be changed. Each difference from one drawing to the next represents the occurrence of an event in the system. As the display of the graphical objects is changed, the flow of events within the system is illustrated.

In addition to determining the differences in graphical objects between successive drawings, new graphical objects added to a drawing in subsequent frames are identified and displayed. Similarly, graphical objects deleted from one drawing frame to the next can be identified and deleted from the display.

A delay may be set for changing the display when a graphical object in the first frame differs from that in a later frame. The delay may be a fixed time or may be set to vary for successive drawing changes to control the pace at which the changes are displayed.

In one embodiment of the invention, the user may specify text to be displayed when the first drawing is displayed, and may specify different text to be displayed for each successive drawing. As a result, the user can describe the flow of events as it is being illustrated by the changes to the graphical objects.

The method may further comprise creating the first drawing and creating the second drawing, wherein the first drawing is a base schematic and the second drawing is an overlay schematic.

The method may further comprise creating a configuration file, with the configuration file comprising at least one a scene title, a text description, or a predefined amount of time between displaying the first drawing and changing the display of the graphical object of the first drawing that is different from the corresponding one of the plurality of graphical objects of the second drawing. The method may further comprise parsing the first drawing, parsing the second drawing, and parsing the configuration file.

The method may further comprise creating an animation file and creating a control file. The animation file may comprise the plurality of graphical objects of the first drawing and the plurality of graphical objects of the second drawing. The control file may comprise instructions to display the plurality of graphical objects of the first drawing, the plurality of graphical objects of the second drawing, the scene title, and the text description.

In addition to the method for animating drawings described above, other aspects of the present invention are directed to corresponding systems and computer program products for animating drawings.

### BRIEF DESCRIPTION OF THE SEVERAL VIEWS OF THE DRAWING(S)

The accompanying drawings illustrate the preferred and exemplary embodiments and are not necessarily drawn to scale.

FIG. 1 is a flowchart of the operation of animating drawings.

FIG. 2 is an electrical schematic drawing illustrating the display of a base schematic created by an illustrator.

FIG. 3 is an electrical schematic drawing illustrating the display generated after applying the changes in the first overlay schematic.

FIG. 4 is an electrical schematic drawing illustrating the display generated after applying the changes in the second overlay schematic.

FIG. 5 is an electrical schematic drawing illustrating the display generated after applying the changes in the third overlay schematic.

FIG. 6 is an electrical schematic drawing illustrating the display generated after applying the changes in the fourth overlay schematic.

FIG. 7 is an electrical schematic drawing illustrating the display generated after the changes in all overlay schematics have been displayed.

FIG. 8 is a schematic block diagram of a system for animating drawings.

### DETAILED DESCRIPTION OF THE INVENTION

The present invention now will be described more fully with reference to the accompanying drawings, in which some, but not all embodiments of the invention are shown. This invention may be embodied in many different forms and should not be construed as limited to the embodiments set forth. Like numbers refer to like elements throughout.

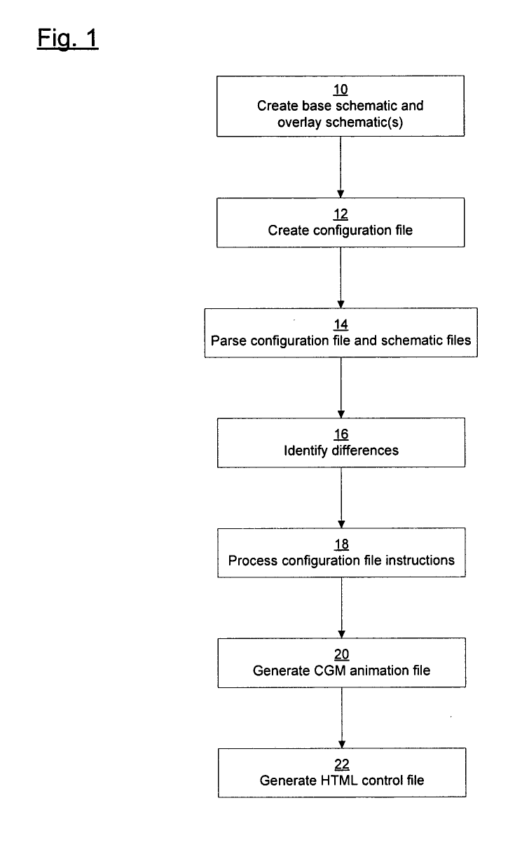

FIG. 1 is a flowchart depicting the animation of drawings, according to one embodiment of the present invention. As shown in step 10 of FIG. 1, the illustrator or user of the present invention typically begins by building a base schematic and a series of overlay schematics. The schematics are typically created in a vector graphic format, such as Computer Graphics Metafile (CGM). A vector graphic format constructs an image as a number of shapes, curves, lines, and text (termed primitives), along with attributes of the primitives, such as placement, color, line weight, transparency, and fill.

The illustrator creates a first overlay that contains one or more slight differences from the base schematic. These differences are typically small, such as changing the color of a component (e.g., to highlight the component) or replacing a component with one having a different orientation (e.g., to show the change of position of a switch arm). Because the overlays are essentially copies of the base schematic with minor changes, once the base schematic is built the additional overlays are quite easy to create. These differences, which may be called transitions, represent the flow of events within the system. After the first overlay is created, a second overlay may be created with the incremental differences from the first overlay. The illustrator may create as many overlays as are required to illustrate the flow of events within the system or subsystem, with each overlay containing one or more slight differences from the preceding overlay.

Typically, the illustrator then prepares a configuration file, as shown in step 12 of FIG. 1. The configuration file specifies the behavior of the animated schematic, such as by grouping the transitions into scenes, specifying the order of the scenes, and providing a scene title and narrative text for each scene as it is viewed by maintenance or other personnel.

The configuration file and the CGM graphic files (i.e., the base schematic and the overlays) are then generally parsed, as shown in step 14. Each instruction in the configuration file is processed in the order it appears in the file. Each time a CGM graphic file is specified in the configuration file, the invention parses the CGM file by identifying each primitive in the file. The primitives of the base schematic and of each of the overlays (also called layers) are stored in the process of parsing the configuration file.

The differences between each drawing and its succeeding drawing are then identified, as shown in step 16. For example, the differences are determined between the base schematic and the first overlay, between the first overlay and the second overlay, and so on until the differences between all successive overlays are identified. As each graphic file is processed and stored, the drawing's appearance is changing because the appearance of one or more individual primitives is changing (e.g., a primitive changes color or is erased) as a result of the application of an overlay. It is said that the drawing has a current state which is defined as its current appearance, which may change over time as one or more overlays are applied to the base schematic. For example, if there are ten overlays along with the base schematic, the drawing will have eleven current states during the processing of the graphic files. As each successive overlay is processed, the changes that occur to each graphical primitive are identified and recorded by comparing the overlay to the current state. The differences are typically determined by comparing each primitive in the current state to each primitive in the successive overlay. It is typically determined (1) if any primitive in the current state is not in the successive overlay; (2) if any primitive in the successive overlay is not in the current state; and/or (3) if any primitive that is in both the current state and the successive overlay has one or more changed attributes, such as location, color, and/or line weight.

The configuration file instructions that have been specified for the current CGM graphic files are then processed, as shown in step 18. This allows the user to control the timing and behavior of the transitions. For example, the user can specify that the first four overlays comprise Scene 1 and the fifth and sixth overlays comprise Scene 2 of the animated schematic. The user can specify that the first overlay display for four seconds before proceeding to the second overlay. There are numerous configuration parameters that allow the user to fine-tune the appearance and behavior of each transition to create a highly interactive and educational experience for the maintenance or other personnel who are viewing the animated schematic.

A CGM animation file is then generated, as shown in step 20. A single file is generally built that contains every graphical primitive (i.e., graphical object) from the base art and the overlays. This file will generally use the CGM format, however any vector graphic format may be used. The CGM animation file contains addressable graphic objects, which enables the control file, such as a Hypertext Markup Language (HTML) control file (also called the animation engine, and discussed in detail below), to dynamically manipulate the graphical objects' attributes, such as color, line weight, text weight, transparency, and fill. As the CGM file is built, if a graphical primitive changes properties (e.g., changes color, is highlighted), it is encapsulated in an addressable object using a CGM Application Program Structure, such as:

BegAPS “O1” “grobject” StList;

APSAttr “name” “14 1 ““Object1”””;

APSAttr “info” “10 1 1”;

APSAttr “data” “14 1 ““id=1”””;

APSAttr “linkuri” “14 1””””;

BegAPSBody;

BegAPSBody;

Line 100 100 200 300;

EndAps;

In this example, the line that begins at the X-Y coordinates of (100, 100) and ends at the X-Y coordinates (200, 300) is given the name Object1. The animation engine can use this name to dynamically reference the line. The specific type (grobject) of this line can also be identified, such that the animation engine knows that this is a graphical object.

If a primitive appears or disappears at any time during the animation (as opposed to having its appearance change), then that primitive's CGM application program structure may be embedded in another application program structure, such as:

BegAPS “IsoL1” “layer” StList;

APSAttr “name” “14 1 ““Layer”””;

APSAttr “info” “10 4 0 0 0 54”;

BegAPSBody;

BegAPS “O1” “grobject” StList;

APSAttr “name” “14 1 ““Obj1”””;

APSAttr “info” “10 1 1”;

APSAttr “data” “14 1 ““id=1”””;

APSAttr “linkuri” “14 1””””;

BegAPSBody;

Line 100 100 200 300;

EndAps;

EndAps;

In this example, the line that begins at the X-Y coordinates of (100, 100) and ends at the X-Y coordinates (200, 300) either appears or disappears during the animation. By creating a layer (named “Layer1”), the animation engine can turn the layer on (to show it) or turn the layer off (to hide it). By creating a graphical object inside the layer (named “Obj1”), the animation engine can change the visual characteristics of the line, such as changing the color or line thickness. In general, this structure allows the animation engine to dynamically show or hide the graphical objects that are inside any application program structure of the type “layer.” While graphical objects do not have to be contained in a layer structure, the use of a layer structure is the preferred method whenever graphical objects are going to be hidden or made visible at some point during the animation. Another method for hiding graphical objects is to change their color to match the background color, thus making them appear invisible. However, changing the color of graphical objects to match the background color may have undesirable effects because such graphical objects often overlay other graphical objects that may also be inadvertently hidden. For example, an image may have a white background and two filled geometric shapes, the two shaped being a large red circle and a small blue triangle. If the triangle is on top of the circle and the triangle is to be hidden, changing the color of the triangle to match the background (white), will not have the affect of making the triangle disappear, but will instead create the affect of a small white triangle on top of a large red circle. In this example, the triangle would need to be embedded in a layer that can be hidden, which will result in only the red circle being visible.

The next step is typically to generate an HTML control file or animation engine, as shown in step 22. The animation engine that is generated knows how to play the scenes embodied in the CGM animation file. This file will generally be implemented using an HTML file with embedded scripting, however other possible implementations will be known to those skilled in the art. Typically, a subroutine is generated for each scene that causes each scene's appearance and behavior effects to occur. At a minimum, the subroutine would identify the base schematic and any overlays to be depicted in the scene, the associated narrative text, and the scene label. The stored primitives and configuration file instructions may be reviewed to find those primitives that are part of the current scene being written, to incorporate those primitives into the subroutine for the current scene. For each change that is to be displayed, the appropriate instructions are generated in the HTML control file (e.g., to hide an object, change the color of a box, thicken a line). The HTML script for a scene might look something like:

```
sub Scene0
  top.Viewer.LoadFile “RampDoorOpen.cgm”
  top.VCR.write2Div “Electrical power is applied, hydraulic
  power is applied. Open ramp, power down can be initiated
  from four different aircraft locations, 1) the cockpit ramp
  control panel (5231BCT1), in automatic mode or manual mode,
  2) the cabin ramp control panel (5231GCT2), 3) the outboard
  maintenance panel (5231KS7), all of which are electrical
  functions, and at 4) the ramp control valve in the aft section of
  the aircraft. Operation from the ramp control valve is
  mechanical. Ground is applied to Ramp Control Valve from
  Ground Bus in No. 3 Circuit Breaker Panel.”
  top.VCR.updateSceneLabel “Static Condition”
  top.VCR.endOfScene
end sub
```

In this example, Scene 0 loads the CGM file (RampDoorOpen.cgm, which in this example is the base schematic) into the viewer frame, displays the first narrative text, and displays the scene label (“Static Condition”) for this animated drawing. A more complex script might look like:

```
    sub Scene 1
      top.VCR.write2Div “28 VDC applied from No. 3 Circuit
      Breaker Panel is applied to operating point of command switch.”
      top. VCR.updateSceneLabel “Scene 1 of 3”
      top.igViewer.Viewer.Iso3SetGrAttribute
“Obj1”,“color”,“255,255,0”
      top.Viewerer.Viewer.Iso3SetGrAttribute “Obj1”,“stroke-
width”,CSTR(3)
      SetTimeout “Scene1.1”, 2000
    end sub
    sub Scene1.1
      top.Viewerer.Viewer.Iso3SetGrAttribute
“Obj2”,“color”,“255,0,0”
      top.Viewerer.Viewer.Iso3SetGrAttribute “Obj2”,“stroke-
width”,CSTR(3)
      top.Viewerer.Viewer.Iso3SetGrAttribute
“Obj3”,“color”,“255,0,0”
      top.Viewerer.Viewer.Iso3SetGrAttribute “Obj3”,“stroke-
width”,CSTR(3)
      SetTimeout “Scene1.2”, 2000
    end sub
    sub Scene1.2
      top.Viewerer.Viewer.SetLayerVisibility “Layer20”,“false”
      top.Viewerer.Viewer.SetLayerVisibility “Layer21”,“true”
      top.VCR.endOfScene
    end sub
```

In this example, Scene 1 begins by displaying the narrative text: “28 VDC applied from No. 3 Circuit Breaker Panel is applied to operating point of command switch,” while continuing to display the base schematic. The narrative text that is displayed would typically replace the narrative text that was previously displayed. The next instruction updates the scene label telling the maintenance or other personnel viewing the animation that this is “Scene 1 of 3.” The next two instructions cause graphical object “Obj1” (which this embodiment of the invention has determined is a rectangle in this example) to be yellow in color (indicated by the respective red, green, and blue values of “255, 255, 0”) and changes the edge thickness of the rectangle to three units (indicated by “CSTR(3)” and increased from the initial edge thickness of 1, which was determined in the base schematic but is not illustrated in this example).

The widening of the edges to visually highlight the object may be specified by the user or it may be automatically performed in accordance with the invention simply because the color of the object was changed from black to non-black or from one non-black color to another non-black color. In one embodiment of the invention, in addition to changing the display of a graphical object based on the difference in the graphical object between two successive drawings, an additional predefined change may be made to the display of the graphical object based on the nature of the difference identified. For example, one embodiment of the invention may be configured such that whenever an object's color changes to red, the object blinks three times when the object's color is changed to red during the animation. Another embodiment of the invention may be configured such that that when a new object appears that contains only text, the new object is faded in slowly to create a more professional look. Yet another embodiment of the invention may be configured such that any change of color of an object from black to non-black or from a first non-black color to a second non-black color, between successive overlays, should be accompanied by widening the lines of the object, to make the animation richer and easier to understand. Correspondingly, any such automatic visual changes may be automatically reversed when the color of an object changes from non-black to black or from the second non-black color back to the first non-black color. In one embodiment, automatic visual changes may be automatically reversed when the final overlay is displayed. In general, any display effects that occur frequently for specific types of events may be defined one time and thereafter automatically occur when a specific difference is identified by the invention. This feature further speeds the creation of the static drawings. Embodiments of the present invention may also be configured to support other automatic changes to further highlight changes and speed development of the animation.

In the above example, the animation engine then waits two seconds (indicated by “2000” [milliseconds]) and calls subroutine Scene 1.1. Scene 1.1 colors two lines (Obj2 and Obj3) red (indicated by “255, 0, 0”), widens these two lines (indicated by “CSTR(3)”), and then waits two seconds before calling subroutine Scene1.2. Scene1.2 hides layer ‘Layer20’ as a result of its designation “false,” reveals layer ‘Layer21’ as a result of its designation “true,” and then notifies the animation engine that the scene is complete.

The HTML control file would typically use an animated drawing player to display the animation to the maintenance or other personnel. This player would typically comprise computer software executing on a personal computer, or software executing on a server and viewed on a client terminal. The animated drawing would typically be displayed on the display element of the personal computer or the client terminal, such as a cathode ray tube (CRT) or a liquid crystal display (LCD). The player would typically provide VCR-like controls for playing the animated drawing, a window for displaying the animated drawing, a text area for displaying the associated narrative as the animated drawing plays, a text area for displaying the scene label, and a hyperlink area for displaying a table of contents that allows the personnel viewing the animation to choose the desired scene. The VCR-like controls would typically allow the personnel viewing the animation to play the animation one scene at a time or straight through. It would allow the viewing personnel to back up to a previous scene or to start over at the beginning. There are many different features that can be implemented in the animated drawing player, depending on the requirements of the viewing personnel.

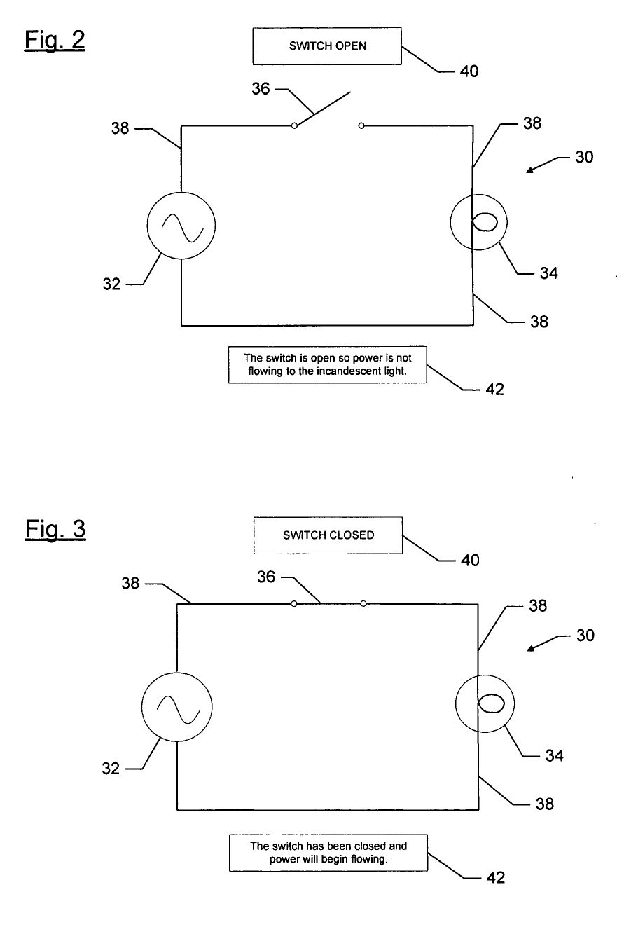

FIGS. 2 through 7 illustrate an example of the animated display of a simple electrical schematic, according to one embodiment of the invention. To create the animated display illustrated in FIGS. 2 through 7, the user would likely have created a base schematic and five overlays. The base schematic, which is illustrated in FIG. 2, illustrates a simple electrical circuit 30 comprising AC power source 32, switch 36 (initially open), incandescent light 34, and electrical conductor 38 connecting the other three elements. All elements of the base schematic are colored black in this example. The first of the five overlays would be identical to the base schematic, except that switch 36 would be closed in the first overlay. The second overlay would be identical to the first overlay, except that AC power source 32 is yellow in color in the second overlay to highlight it as it is textually described. The third overlay would be identical to the second overlay, except that electrical conductor 38 is red in color in the third overlay to indicate electrical current flowing through the circuit. The fourth overlay would be identical to the third overlay, except that incandescent light 34 is yellow in color in the fourth overlay to indicate that it is on. The fifth overlay would be identical to the fourth overlay, except that the color of all elements has been changed back to black to indicate the end of the animation.

After creating the base schematic and the overlays as described above, the user in this example would have created a configuration file specifying the order in which the overlays are to be displayed, as well as labels and text to be displayed with each overlay. For example, the text accompanying the first overlay might describe the location and technical specifications of switch 36, and the label might read “Switch Closed.”

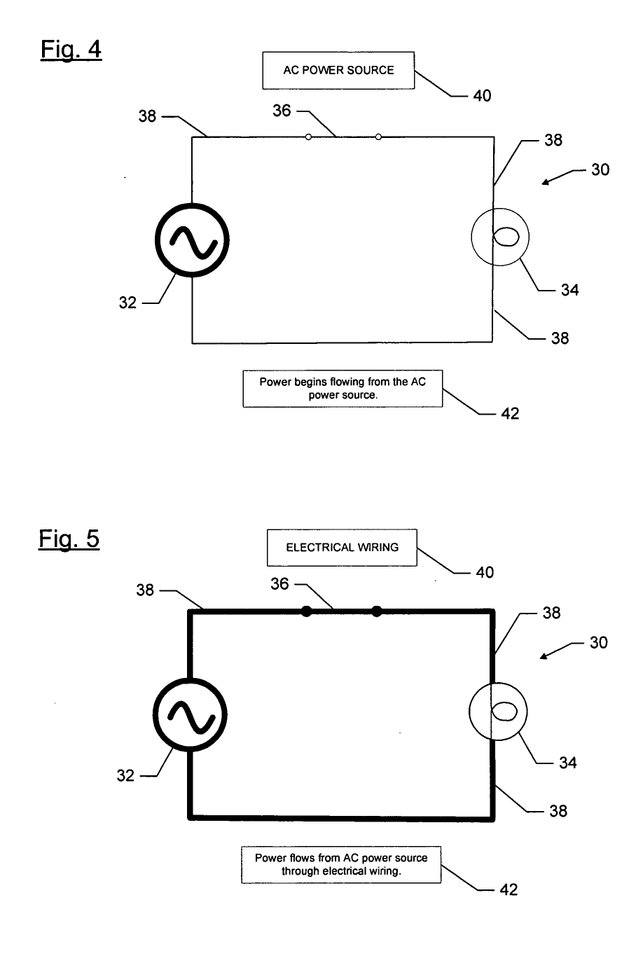

The configuration file and schematic files would then be parsed, the differences between successive overlays would be identified, the configuration file instructions would be processed, and the CGM animation file and the HTML control file would be generated, as discussed in detail above. The HTML control file would use the animated drawing player to display the transitions in each overlay, as illustrated in FIGS. 2 through 7, to be viewed by maintenance or other personnel. FIG. 2 illustrates the display of the base schematic. In FIG. 2, all elements of the circuit are colored black. FIG. 2 also illustrates a label 40 (“SWITCH CLOSED”) and a text description 42 (“The switch is open so power is not flowing to the incandescent light.”) being displayed based on instructions in the configuration file. FIG. 3 illustrates the display of the first overlay applied to the base schematic, such that switch 36 goes from open in FIG. 2 to closed in FIG. 3. This change would be implemented in the HTML control file by deleting one line (the angled line of FIG. 2 indicating an open switch) and adding one line (the horizontal line of FIG. 3 indicating a closed switch). The label 40 and the text description 42 have also been changed in FIG. 3 to describe the current state. FIG. 4 illustrates the display of the second overlay applied to the previous current state (i.e., the base schematic with the first overlay applied), such that AC power source 32 is displayed as yellow in color. In this example, the lines of AC power source 32 are widened to further highlight this element. This widening of the lines is done automatically in this example because the color of this element was changed from black to non-black. Again, the label 40 and the text description 42 have been changed to describe the current state.

FIG. 5 illustrates the display of the third overlay applied to the previous current state (i.e., the base schematic with the first and second overlays applied), such that electrical conductor 38 is displayed as red in color. In this example, the lines of electrical conductor 38 are widened to further highlight this element. This widening of the lines is done automatically in this example because the color of this element was changed from black to non-black. The label 40 and the text description 42 have again been changed to describe the current state.

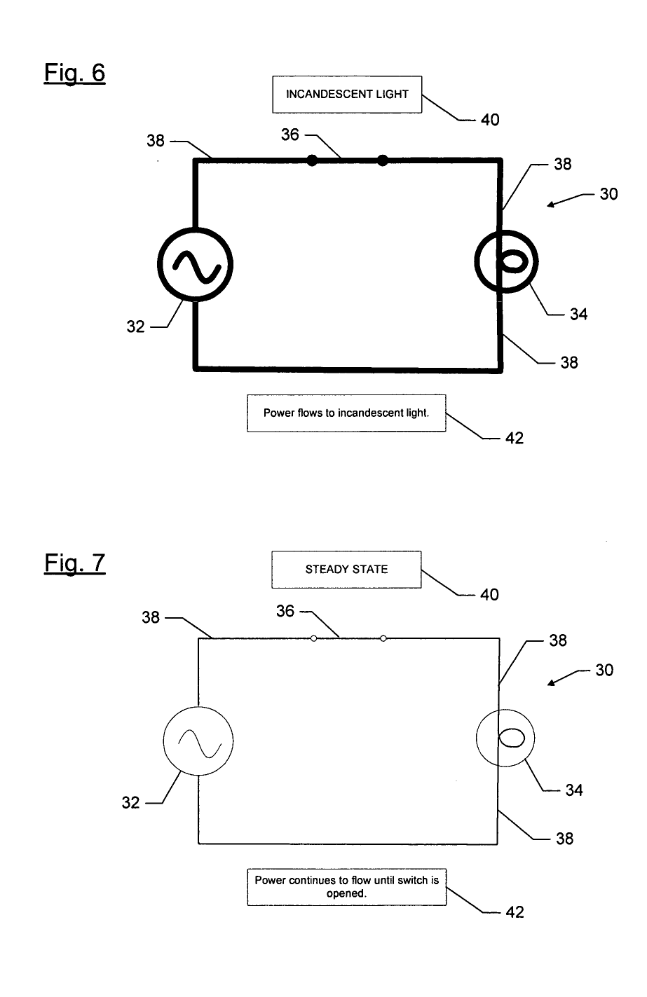

FIG. 6 illustrates the display of the fourth overlay applied to the previous current state (i.e., the base schematic with the first, second, and third overlays applied), such that incandescent light 34 is displayed as yellow in color. In this example, the lines of incandescent light 34 are widened to further highlight this element. This widening of the lines is done automatically in this example because the color of this element was changed from black to non-black. The label 40 and the text description 42 have been changed to describe the current state.

FIG. 7 illustrates the display of the fifth overlay applied to the previous current state (i.e., the base schematic with the first, second, third, and fourth overlays applied), such that all elements of the circuit are displayed as black in color. In this example, the lines of all the elements are thinned to their original width. This thinning of the lines is done automatically in this example because the color of these elements was changed from non-black to black. The label 40 and the text description 42 have been changed to describe the current state.

While embodiments of the invention have been described in terms of animating electrical schematic drawings, the present invention could be used to animate many different types of illustrations, including, but not limited to, wiring diagrams, hydraulic schematics, mechanical systems, and structural drawings.

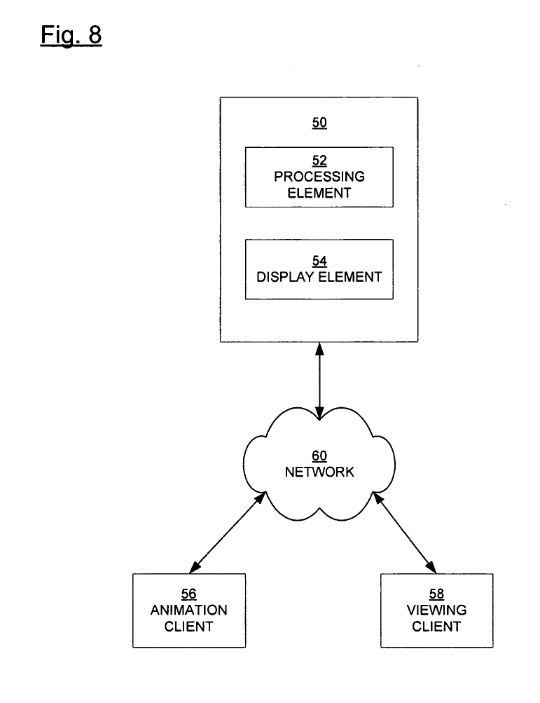

FIG. 8 is a schematic block diagram of a system for animating drawings, according to one embodiment of the present invention. FIG. 8 illustrates a system using a client/server configuration. A illustrator interfaces with the system via animation client 56, which may be a personal computer or a terminal, for example. Animation client 56 communicates with server 50 over network 60. Network 60 may be the Internet, for example, or any other suitable network. The resulting drawing animation may be viewed by maintenance or other personnel via viewing client 58, which may be a personal computer or a terminal, for example, and which may also communicate with server 50 over network 60.

In one embodiment of the present invention, server 50 may contain a number of different elements to allow drawing animations to be created and viewed. Server 50 may contain processing element 52 for identifying the base schematic and overlays created by a illustrator and for determining the differences between the base schematic and each of the overlays. Server 50 may also contain display element 54 for displaying the base schematic and for changing the display to reflect changes in the overlays as each overlay is processed. Display element 54 of server 50 may merely format the display of the base schematic and overlays, with the actual display occurring at viewing client 58.

While FIG. 8 illustrates a system of the present invention using a client/server configuration, the client/server configuration is shown for example purposes only and the system of the present invention could use configurations other than client/server. It should also be appreciated that the overall system architecture shown in FIG. 8 is for example purposes only, and not intended to limit the scope of the present invention. The system of the present invention could be implemented using a number of different system configurations.

The method of animating drawings may be embodied by a computer program product. The computer program product includes a computer-readable storage medium, such as a non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIG. 1 is a flowchart of methods and program products according to the invention. It will be understood that each step of the flowchart, and combinations of steps in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

The system, method, and computer program product of the present invention provide a novel method for building animated graphics that illustrates the theory of operations for complex systems. The need for animation software that is expensive and that requires special skills not typically possessed by illustrators is eliminated. Illustrators can continue to use the same drafting software they are familiar with to produce a sequence of static schematic drawings, called a storyboard, which the system, method, and computer program product of the present invention automatically convert into an animation. As these static schematic drawings can typically be created quickly, creating the series of drawings required to animate the flow of events, once an initial drawing is created, takes little additional time. This substantially reduces the cost and difficulty of building these types of animations. As a result, manufacturers of complex systems are able to easily provide these useful maintenance tools to their customers.

The invention is not limited to the specific disclosed embodiments. Although specific terms are employed herein, they are used in a generic and descriptive sense only and not for purposes of limitation.

That which is claimed:

1. A method of animating drawings comprising:
displaying a first drawing comprising a plurality of graphical objects;
identifying a second drawing comprising a plurality of graphical objects;
determining which of the plurality of graphical objects of the first drawing is different from corresponding ones of the plurality of graphical objects of the second drawing; and
changing the display of the graphical object of the first drawing that is different from the corresponding one of the plurality of graphical objects of the second drawing to match the corresponding one of the plurality of graphical objects of the second drawing.

2. The method of claim 1, wherein changing the display of the graphical object further comprises changing the display of the graphical object of the first drawing that is different from the corresponding one of the plurality of graphical objects of the second drawing in a predefined manner based on the difference between the graphical object of the first drawing and the corresponding one of the plurality of graphical objects of the second drawing.

3. The method of claim 1, further comprising:
determining which of the plurality of graphical objects of the first drawing is not present in the second drawing; and
removing the display of the graphical object of the first drawing that is not present in the second drawing.

4. The method of claim 1, further comprising:
determining which of the plurality of graphical objects of the second drawing is not present in the first drawing; and
displaying the graphical object of the second drawing that is not present in the first drawing.

5. The method of claim 1, further comprising waiting a predefined amount of time between displaying the first drawing and changing the display of the graphical object of the first drawing that is different from the corresponding one of the plurality of graphical objects of the second drawing.

6. The method of claim 1, further comprising:
displaying text associated with the first drawing when the first drawing is displayed; and
displaying text associated with the second drawing when the display is changed.

7. The method of claim 1, further comprising:
creating the first drawing, wherein the first drawing is a base schematic; and
creating the second drawing, wherein the second drawing is an overlay schematic.

8. The method of claim 1, further comprising:
creating a configuration file, the configuration file comprising at least one a scene title, a text description, or a predefined amount of time between displaying the first drawing and changing the display of the graphical object of the first drawing that is different from the corresponding one of the plurality of graphical objects of the second drawing.

9. The method of claim 8, further comprising:
parsing the first drawing;
parsing the second drawing; and
parsing the configuration file.

10. The method of claim 8, further comprising:
creating an animation file, the animation file comprising the plurality of graphical objects of the first drawing and the plurality of graphical objects of the second drawing; and
creating a control file, the control file comprising instructions to display the plurality of graphical objects of the first drawing, the plurality of graphical objects of the second drawing, the scene title, and the text description.

11. A system for animating drawings comprising:
a processing element capable of identifying a second drawing comprising a plurality of graphical objects, the processing element further capable of determining which of a plurality of graphical objects of a first drawing is different from corresponding ones of the plurality of graphical objects of the second drawing; and
a display device capable of displaying the first drawing, the display device further capable of changing the display of the graphical object of the first drawing that is different from the corresponding one of the plurality of graphical objects of the second drawing to match the corresponding one of the plurality of graphical objects of the second drawing.

12. The system of claim 11, wherein the display device is further capable of changing the display of the graphical object of the first drawing that is different from the corresponding one of the plurality of graphical objects of the second drawing in a predefined manner based on the difference between the graphical object of the first drawing and the corresponding one of the plurality of graphical objects of the second drawing.

13. The system of claim 11, wherein the processing element is further capable of determining which of the plurality of graphical objects of the first drawing is not present in the second drawing, and wherein the display device is further capable of removing the display of the graphical object of the first drawing that is not present in the second drawing.

14. The system of claim 11, wherein the processing element is further capable of determining which of the plurality of graphical objects of the second drawing is not present in the first drawing, and wherein the display device is further capable of displaying the graphical object of the second drawing that is not present in the first drawing.

15. The system of claim 11, wherein the display device is further capable of waiting a predefined amount of time between displaying the first drawing and changing the display of the graphical object of the first drawing that is different from the corresponding one of the plurality of graphical objects of the second drawing.

16. The system of claim 11, wherein the display device is further capable of displaying text associated with the first drawing when the first drawing is displayed, and wherein the display device is further capable of displaying text associated with the second drawing when the display is changed.

17. A computer program product for animating drawings, the computer program product comprising at least one computer-readable storage medium having computer-readable program code portions stored therein, the computer-readable program code portions comprising:
a first executable portion capable of displaying a first drawing comprising a plurality of graphical objects;
a second executable portion capable of identifying a second drawing comprising a plurality of graphical objects;
a third executable portion capable of determining which of the plurality of graphical objects of the first drawing is different from corresponding ones of the plurality of graphical objects of the second drawing; and
a fourth executable portion capable of changing the display of the graphical object of the first drawing that is different from the corresponding one of the plurality of graphical objects of the second drawing to match the corresponding one of the plurality of graphical objects of the second drawing.

18. The computer program product of claim 17, wherein the fourth executable portion is further capable of changing the display of the graphical object of the first drawing that is different from the corresponding one of the plurality of graphical objects of the second drawing in a predefined manner based on the difference between the graphical object of the first drawing and the corresponding one of the plurality of graphical objects of the second drawing.

19. The computer program product of claim 17, further comprising:
a fifth executable portion capable of determining which of the plurality of graphical objects of the first drawing is not present in the second drawing; and
a sixth executable portion capable of removing the display of the graphical object of the first drawing that is not present in the second drawing.

20. The computer program product of claim 17, further comprising:
a fifth executable portion capable of determining which of the plurality of graphical objects of the second drawing is not present in the first drawing; and
a sixth executable portion capable of displaying the graphical object of the second drawing that is not present in the first drawing.

21. The computer program product of claim 17, wherein the fourth executable portion waits a predefined amount of time after the first executable portion displays the first drawing before changing the display of the graphical object of the first drawing that is different from the corresponding one of the plurality of graphical objects of the second drawing.

22. The computer program product of claim 17, further comprising:
a fifth executable portion capable of displaying text associated with the first drawing when the first drawing is displayed; and further capable of displaying text associated with the second drawing when the display is changed.

23. The computer program product of claim 17, further comprising:
a fifth executable portion capable of parsing the first drawing;
a sixth executable portion capable of parsing the second drawing; and
a sevent executable portion capable of parsing a configuration file, wherein the configuration file comprises at least one a scene title, a text description, or a predefined amount of time between displaying the first drawing and changing the display of the graphical object of the first drawing that is different from the corresponding one of the plurality of graphical objects of the second drawing.

24. The computer program product of claim 17, further comprising:
a fifth executable portion capable of creating an animation file, the animation file comprising the plurality of graphical objects of the first drawing and the plurality of graphical objects of the second drawing; and
a sixth executable portion capable of creating a control file, the control file comprising instructions to display the plurality of graphical objects of the first drawing, the plurality of graphical objects of the second drawing, the scene title, and the text description.
